(19) United States
(12) Patent Application Publication
(10) Pub. No.: US 2023/0064420 A1
(43) Pub. Date: Mar. 2, 2023

(54) TWO-WAY VALVE

(71) Applicant: CEBI ELECTROMECHANICAL COMPONENTS SPAIN, S.A, VILLATUERTA (Navarra) (ES)

(72) Inventors: DIEGO SAN JULIAN GARCIA, VILLATUERTA (Navarra ) (ES); JAVIER GARCIA IZAGUIRRE, VILLATUERTA (Navarra ) (ES); SERGIO DIEZ GARCIA, VILLATUERTA (Navarra ) (ES)

(21) Appl. No.: 17/819,070

(22) Filed: Aug. 11, 2022

(30) Foreign Application Priority Data
Aug. 26, 2021 (ES) U202131717

(51) Int. Cl. F16K 17/04; F01P 3/12

(52) U.S. Cl. CPC F16K 17/0473; F01P 3/12

(57) ABSTRACT

A two-way valve having a central body with a first end and a second end, the central body has a first internal valve and a second internal valve, the first internal valve enables the passage of a fluid along a first internal path only in the direction that goes from the second end to the first end of the central body, when a first fluid pressure threshold is exceeded, and the second internal valve enables the passage of a fluid along a second internal path only in the direction that goes from the first end to the second end of the central body, when a second fluid pressure threshold is exceeded, characterized in that a first axis of symmetry of the first internal path and a second axis of symmetry of the second internal path are parallel to each other and parallel to a longitudinal axis of the central body.

### CROSS-REFERENCE TO RELATED APPLICATION

This application claims priority of Spanish Patent Application No. U202131717, filed Aug. 26, 2021, the contents of which are incorporated herein by reference.

### TECHNICAL FIELD

The object of the present invention is a two-way valve specially designed for a cooling circuit of a vehicle.

Preferably, the two-way valve object of the present invention is especially suitable for use in a cooling circuit of an electric vehicle.

The two-way valve object of the present invention offers a compact design and can be manufactured in a simple manner, reducing the number of components with respect to other two-way valves of the state of the art, guaranteeing optimum performance and a reduced manufacturing cost.

The two-way valve object of the present invention has application in the automobile industry and, more specifically, in the industry dedicated to the design and manufacture of hydraulic circuit components for automobiles.

### STATE OF THE ART

Motor vehicles comprise one or more cooling circuits intended to cool certain components of the drive system, as well as intended to cool air to be introduced into the passenger compartment of the vehicle, as part of an air conditioning system.

These cooling systems have a cooling fluid circuit (formed, for example, from a mixture of water with glycol) that runs in proximity to the components that must be cooled. Due to the fact that the cooling fluid can expand and/or contract when it absorbs or gives off heat respectively, and/or when it is subjected to pressure variations, it is essential to have an expansion chamber for the cooling fluid in the cooling systems of the vehicles.

Expansion chambers typically have a plug, which must be removed when the circuit with cooling fluid is to be filled. Usually, the plugs of said expansion chambers have two valves that allow the outside air to enter or exit, when the cooling fluid/liquid expands or contracts in the cooling fluid circuit respectively.

Likewise, the expansion chambers are usually arranged interspersed in the cooling liquid circuit or circuits, and have a lower conduit to feed the circuit with cooling fluid, and an upper conduit to receive cooling fluid from the circuit.

However, the expansion tanks or chambers can be made with a single outlet/inlet conduit of cooling fluid. This concept of the expansion chamber is used in a cooling fluid circuit in which the expansion chamber is not interspersed in the cooling fluid circuit(s), but is simply in fluid connection with the circuit(s) to allow expansion of the cooling fluid in each circuit (receiving cooling fluid) or to allow the contraction of the cooling fluid (providing cooling fluid to the circuit or circuits), avoiding negative pressure in the circuit and the consequent risk of collapse of the circuit hoses.

According to the concept of the cooling fluid circuit described in the previous paragraph, wherein the expansion chamber has a single outlet/inlet conduit of cooling fluid, a two-way valve must be arranged in said outlet/inlet conduit of the expansion chamber. This two-way valve is calibrated to enable the inlet of cooling fluid into the expansion chamber when the pressure of the cooling fluid in the circuit exceeds a predetermined maximum threshold value. Likewise, the two-way valve is calibrated to enable the exit of cooling liquid/fluid towards the circuit or circuits, when the pressure of the cooling fluid in said circuit or circuits decreases below a predetermined minimum threshold value.

To comply with the functionality described in the previous paragraph, two-way valves internally have a double fluid inlet and outlet path, each of the paths with its own valve or internal shutter system. In order to obtain a greater compactness of the two-way valve, the two paths (with the respective valves or shutter systems thereof) of the two-way valve are usually arranged concentrically with respect to each other, and centred with respect to the axis of the inlet and outlet channels or pipettes of the two-way valve. Documents CN 101382207 A, EP 0180208 A2 and WO 8809429 A1 describe two-way concentric valves for a cooling circuit.

For an application in vehicles with internal combustion engines, the maximum admissible pressure of the cooling fluid in the cooling circuit is usually around 250 kPa. For its part, the minimum threshold value of cooling fluid pressure in the cooling circuit (to avoid a collapse of the circuit hoses) is usually around 5 kPa.

However, for an application in electric traction vehicles, the maximum and minimum thresholds of cooling fluid pressure in the cooling circuit are usually around 30 kPa and 5 kPa, respectively.

As can be seen, in an application for electric traction vehicles, the maximum and minimum threshold values of the cooling fluid pressure in the cooling circuit are much closer to each other than in an application for vehicles with internal combustion engines.

Since the calibration or setting of the internal elements of the two-way valve depend on the maximum and minimum threshold values allowed for the cooling fluid pressure in the cooling circuit, these threshold values must be taken into consideration when designing the two-way valve for each specific application.

Concentric two-way valves have been found to offer very good performance for applications in vehicles with internal combustion engines. In this application, the design of the concentric two-way valve is relatively simple since the high difference between the maximum and minimum threshold values for the cooling fluid pressure in the cooling circuit allows that, despite the high degree of compactness of the concentric configuration, the pressure relief valve (calibrated or designed to open when the maximum admissible threshold value of cooling fluid pressure in the cooling circuit is reached) has a shutter with a diameter much larger than the diameter of the compensation valve shutter (calibrated or designed to open when the minimum admissible threshold value of cooling fluid pressure is reached in the cooling circuit). This difference in diameters enables the compensation valve to be mounted on the closing element (shutter) of the pressure relief valve.

However, for an application in electric traction vehicles, the greater proximity between the maximum and minimum admissible threshold values for the cooling fluid pressure in the cooling circuit implies that the diameters of the shutters or closing elements of the pressure relief valve and of the compensation valve, internal to the two-way valve, are much more similar to each other. This makes it difficult to design a two-way concentric valve for applications in cooling systems of electric traction vehicles, due to the overlapping of the dimensions of the closing elements of both internal valves and the corresponding seats thereof.

Certainly, starting from a configuration of a concentric two-way valve with similar diameters of the shutters of the internal valves, it is possible to propose an alteration of the two-way valve design by increasing the difference between the diameters of the internal shutters to arrive at a situation such as that which is observed in two-way concentric valves for cooling systems of vehicles with internal combustion engines. This alteration involves adjusting the stiffness values of the respective antagonist springs of the pressure relief valve and of the compensation valve. However, despite the fact that this strategy is feasible a priori, it can potentially lead to non-optimal configurations from various points of view; size or stiffness of the springs, minimum passage sections required for each valve, etc. Thus, for example, the mass of the shutter of the pressure relief valve (which includes the compensation valve) is a critical parameter. For the case at hand (electric traction vehicles), wherein the opening pressures of the pressure relief valve are low, the combination of a heavy shutter with a flexible spring is not safe and could lead to dynamic instabilities.

### OBJECT OF THE INVENTION

In order to solve the aforementioned drawbacks, the present invention relates to a two-way valve.

The two-way valve object of the present invention comprises a central body with a first end and a second end. The central body comprises a first internal valve (or pressure relief valve) and a second internal valve (or compensation valve).

The first internal valve is configured to enable the passage of a fluid along a first internal path of the central body, only in the direction that goes from the second end to the first end of the central body, as long as a first fluid pressure threshold is exceeded in the first internal path. Upon exceeding this first fluid pressure threshold in the first internal path, the first internal valve opens (by overcoming the elastic force of the spring of the first internal valve).

The second internal valve is configured to enable the passage of a fluid along a second internal path of the central body, only in the direction that goes from the first end to the second end of the central body, as long as a second fluid pressure threshold is exceeded in the second internal path. When this second fluid pressure threshold is exceeded in the second internal path, the second internal valve opens (by overcoming the elastic force of the spring of the second internal valve).

In a novel way, in the two-way valve object of the present invention, a first axis of symmetry of the first internal path and a second axis of symmetry of the second internal path are parallel to each other and spaced parallel to a longitudinal axis of the central body.

Through this configuration, there are two internal paths for passing fluid in the central body of the two-way valve, the axes of symmetry of which are eccentric with respect to the longitudinal axis of the central body. This configuration makes it possible to solve the problems of setting or calibrating the elements of the internal valves, allowing the two internal valves to be designed completely independently, which is especially important in cases wherein, as mentioned, the operating parameters (opening pressure thresholds) of the internal valves are very similar to each other.

Preferably, a first valve seat of the first internal valve and a second valve seat of the second internal valve are located in different transversal planes (planes orthogonal to the longitudinal axis) of the central body. This feature helps to facilitate a totally independent design of the two internal valves of the central body.

According to a preferred embodiment of the present invention, the two-way valve comprises a first terminal body configured to be connected to an expansion chamber of a fluid and a second terminal body configured to be connected to a conduit of a fluid circuit, wherein the first terminal body is configured to be attached to the first end of the central body by means of spin welding, and wherein the second terminal body is configured to be attached to the second end of the central body by means of spin welding. By means of this feature, it is possible to equip the two-way valve with great assembling simplicity, eliminating sealing gaskets the placing of which is usually difficult in other types of valves, and the maintenance of which limits the useful life of the valve. Spin welding ensures a firm connection of the bodies of the two-way valve, while guaranteeing the tightness in the connection of the terminal bodies with the central body. In addition, this type of welding avoids the defects that occur with ultrasonic welding that varies the load value of the valve spring.

According to the preferred embodiment of the two-way valve, the first internal valve comprises a first shutter element, a first spring and a first support element configured to support the first spring. The choice of the elastic constant of the first spring as well as the dimensions of the first shutter element is carried out taking into account the first opening pressure threshold value of the first internal valve.

According to a preferred embodiment, the first shutter element comprises a spherical geometry and is preferably made of an elastomeric material.

The first support element comprises at least one hole configured to enable the passage of fluid through the first support element when the first valve is opened.

According to the preferred embodiment of the two-way valve, the second internal valve comprises a second shutter element, a second spring and a second support element configured to support the second spring. As mentioned with respect to the first internal valve, also in this case, the choice of the elastic constant of the second spring as well as the dimensions of the second shutter element is carried out taking into account the second opening pressure threshold value of the second internal valve.

According to a preferred embodiment, the second shutter element comprises a disc-shaped geometry and is preferably made of an elastomeric material.

The second support element comprises at least one hole configured to enable the passage of fluid through the second support element when the second valve is opened.

Preferably, the second internal valve comprises an interposition element configured as an interposition means between the second spring and the second shutter element. By means of this feature, it is possible to standardise the pressure exerted by the second spring on the second shutter element, as well as to improve the stability of the second shutter element, avoiding the deformation thereof, which is especially useful in the preferred case in which the second shutter element has a disc-shaped geometry.

### DESCRIPTION OF THE FIGURES

The following figures have been included as part of the explanation of at least one embodiment of the invention.

FIG. 1 shows a schematic cross-sectional view of a possible embodiment of the two-way valve object of the present invention.

FIG. 2 shows a schematic cross-sectional view of the central body of the two-way valve, according to the embodiment of FIG. 1.

FIG. 3 shows a schematic cross-sectional view of the central body of the two-way valve, wherein said central body is rotated 180° with respect to the view shown in FIG. 2.

FIG. 4 shows an exploded perspective right side view of the two-way valve, according to the embodiment of FIG. 1.

FIG. 5 shows an exploded perspective right side view of the two-way valve, wherein the ends of the two-way valve are shown in an inverted position with respect to what is shown in FIG. 4.

FIG. 6 shows an exploded perspective left side view of the two-way valve of FIG. 5.

FIG. 7 shows a perspective view of the central body of the two-way valve, according to the embodiment of FIG. 1.

FIG. 8 shows a perspective view of the central body of the two-way valve, wherein the ends of the central body are shown in an inverted position with respect to that which is shown in FIG. 7.

### DETAILED DESCRIPTION OF THE INVENTION

The present invention relates, as mentioned above, to a two-way valve.

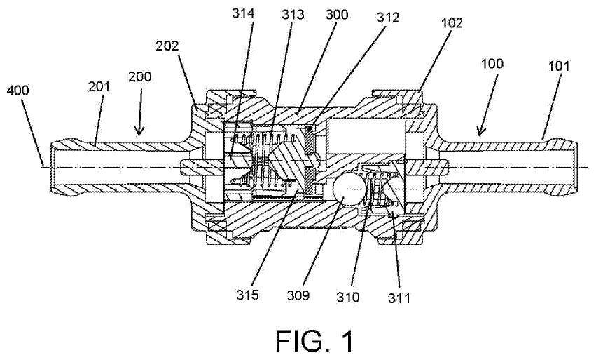

FIG. 1 schematically shows a cross-sectional view of a possible embodiment of the two-way valve object of the present invention.

The two-way valve comprises a first terminal body (100), a second terminal body (200) and a central body (300).

The first terminal body (100) and the second terminal body (200) comprise a symmetry of revolution with respect to a longitudinal axis (400) of the two-way valve. In contrast, the central body (300) does not comprise said symmetry of revolution with respect to the longitudinal axis (400) of the two-way valve.

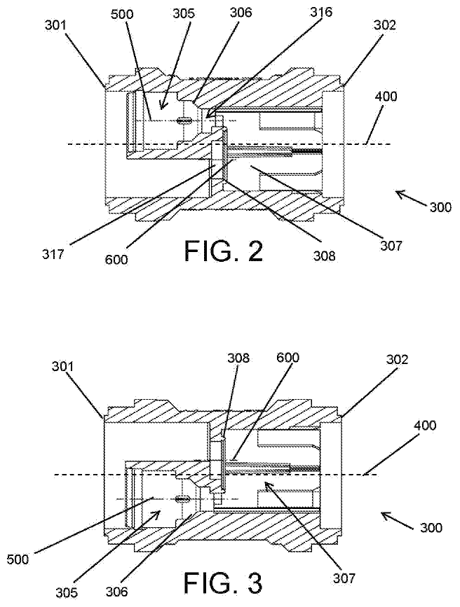

FIG. 2 and FIG. 3 show respective cross-sectional views of the central body (300) of the two-way valve.

The central body (300) comprises a first end (301) arranged in correspondence with the first terminal body (100) of the two-way valve, and a second end (302) arranged in correspondence with the second terminal body (200) of the two-way valve.

In FIG. 2 and FIG. 3, the first end (301) of the central body (300) is shown on the left of the Figure, while in FIG. 1 said first end (301) of the central body is shown on the right of the figure.

For its part, in FIG. 2 and FIG. 3, the second end (302) of the central body (300) is shown on the right of the Figure, while in FIG. 1 said second end (302) of the central body is represented on the left of the figure.

The central body (300) comprises a first internal valve (303) or pressure relief valve, and a second internal valve (304) or compensation valve.

The first internal valve (303) or pressure relief valve is located in a first housing (305) comprising a first valve seat (306).

The second internal valve (304) or compensation valve is located in a second housing (307) comprising a second valve seat (308).

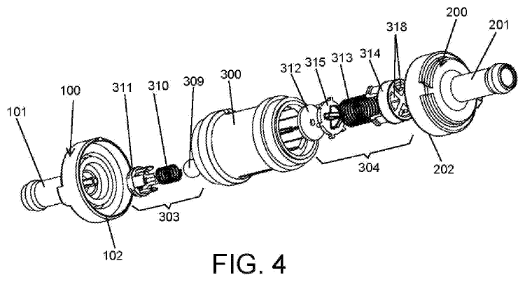

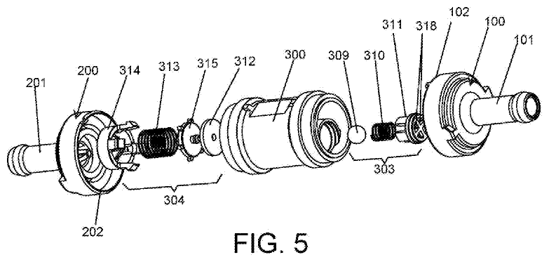

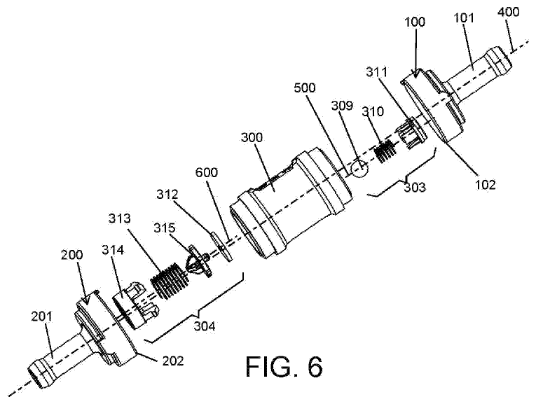

FIG. 4, FIG. 5 and FIG. 6 show exploded views of the two-way valve.

As can be seen, the first internal valve (303) or pressure relief valve comprises a first shutter element (309), a first spring (310) and a first support element (311) configured to support the first spring (310).

For its part, as can be seen in FIG. 4, FIG. 5 and FIG. 6, the second internal valve (304) or compensation valve comprises a second shutter element (312), a second spring (313), a second support element (314) configured to support the second spring (313), and an interposition element (315) configured as an interposition means between the second spring (313) and the second shutter element (312).

The first shutter element (309) comprises a spherical geometry and is configured to seal a first internal path (316) of cooling fluid when abutting against the first valve seat (306) of the first housing (305).

The second shutter element (312) comprises a disc-shaped geometry and is configured to seal a second internal path (317) of cooling fluid when abutting against the second valve seat (308) of the second housing (307).

Both the first shutter element (309) and the second shutter element (312) are preferably made of elastomeric material.

Both the first support element (311) and the second support element (314) comprise a base provided with one or more holes (318) or openings, configured to enable the passage of cooling fluid after the first internal valve (303) or pressure relief valve is opened, and the second internal valve (304) or compensation valve is opened respectively.

The first internal path (316) of cooling fluid is shaped about a first axis (500) of local symmetry, and the second internal path (317) of cooling fluid is shaped about a second axis (600) of local symmetry.

The first axis (500) of local symmetry of the first internal path (316) of cooling fluid and the second axis (600) of local symmetry of the second internal path (317) of cooling fluid are parallel to each other, and offset in a manner parallel with respect to the longitudinal axis (400) of the two-way valve. Thus, both the first axis of local symmetry (500) and the second axis of local symmetry (600) are eccentrically arranged on opposite sides with respect to the longitudinal axis (400) of the two-way valve.

Likewise, the first valve seat (306) and the second valve seat (308) are located in different transversal planes of the central body (300).

The first terminal body (100) of the two-way valve comprises a first cannula (101) or pipette configured to be connected to the inlet/outlet conduit of an expansion chamber of a cooling fluid.

The second terminal body (200) comprises a second cannula (201) or pipette, configured to be connected to a conduit or hose of a cooling circuit.

The first terminal body (100) of the two-way valve comprises a first connection area (102) (or connection edge) configured for connecting by means of spin welding with the first end (301) of the central body (300).

The second terminal body (200) of the two-way valve comprises a second connection area (202) (or connection edge) configured for connecting by means of spin welding with the second end (302) of the central body (300).

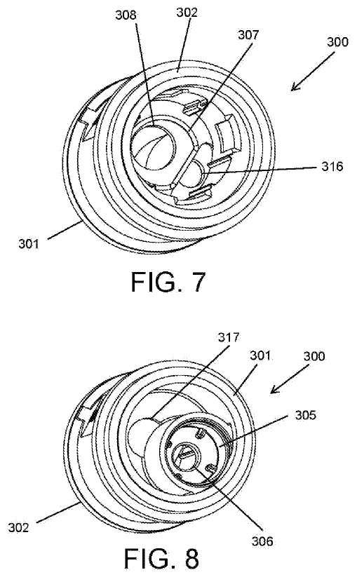

FIG. 7 and FIG. 8 show two perspective views of the central body (300) with the respective first housing (305) and first valve seat (306) for the first internal valve (303) or pressure relief valve, and second housing (307) and second valve seat (308) for the second internal valve (304) or compensation valve.

1. A two-way valve comprising a central body with a first end and a second end, wherein the central body comprises a first internal valve and a second internal valve, wherein the first internal valve is configured to enable the passage of a fluid along a first internal path only in a direction that goes from the second end to the first end of the central body, when a first fluid pressure threshold is exceeded, and wherein the second internal valve is configured to enable the passage of a fluid along a second internal path only in a direction that goes from the first end to the second end of the central body, when a second fluid pressure threshold is exceeded, wherein a first axis of symmetry of the first internal path and a second axis of symmetry of the second internal path are parallel to each other and parallel to a longitudinal axis of the central body.

2. The two-way valve according to claim 1, wherein a first valve seat of the first internal valve and a second valve seat of the second internal valve are located in different transversal planes of the central body.

3. The two-way valve according to claim 1, further comprising a first terminal body configured to be connected to an expansion chamber of a fluid and a second terminal body configured to be connected to a conduit of a fluid circuit, wherein the first terminal body is configured to be attached to the first end of the central body by means of spin welding, and wherein the second terminal body is configured to be attached to the second end of the central body by means of spin welding.

4. The two-way valve according to claim 1, wherein the first internal valve comprises a first shutter element, a first spring and a first support element configured to support the first spring.

5. The two-way valve according to claim 4, wherein the first shutter element comprises a spherical geometry.

6. The two-way valve according to claim 4, wherein the first shutter element is made of an elastomeric material.

7. The two-way valve according to claim 4, wherein the first support element comprises at least one hole configured to enable the passage of fluid through the first support element when the first valve is opened.

8. The two-way valve according to claim 1, wherein the second internal valve comprises a second shutter element, a second spring and a second support element configured to support the second spring.

9. The two-way valve according to claim 8, wherein the second shutter element comprises a disc-shaped geometry.

10. The two-way valve according to claim 8, wherein the second shutter element is made of an elastomeric material.

11. The two-way valve according to claim 8, wherein the second support element comprises at least one hole configured to enable the passage of fluid through the second support element when the second valve is opened.

12. The two-way valve according to claim 8, wherein the second internal valve comprises an interposition element configured as an interposition means between the second spring and the second shutter element.
